(19) United States
(12) Patent Application Publication
(10) Pub. No.: US 2026/0186117 A1
(43) Pub. Date: Jul. 2, 2026

(54) Method and Apparatus for Providing Training Data Sets for a Classification Model for Object Identification for an Ultrasonic Sensor System in a Mobile Device

(71) Applicant: Robert Bosch GmbH, Stuttgart (DE)

(72) Inventors: Tom Reimann, Bissingen An Der Teck (DE); Thomas Geiler, Aidlingen (DE); Michael Tchorzewski, Boeblingen (DE); Tobias Wingert, Leonberg (DE)

(21) Appl. No.: 18/866,393

(22) PCT Filed: Apr. 24, 2023
(86) PCT No.: PCT/EP2023/060645

§ 371 Date: Nov. 15, 2024

(30) Foreign Application Priority Data
Jun. 1, 2022 (DE) 10 2022 205 574.8

(51) Int. Cl. G01S 7/539; G01S 15/931; G06F 18/241

(52) U.S. Cl. CPC G01S 7/539; G01S 15/931; G06F 18/241

(57) ABSTRACT

A method, in particular a computer-implemented method, is for training a data-based classification model for a configuration of a new ultrasonic sensor system including a plurality of ultrasonic transducers using training data sets. The classification model specifies, for one or more surrounding objects, at least one class for an object property. A training data set assigns an input data set from sensor data of an ultrasonic transducer and/or from sensor data features derived therefrom to a classification vector for the one or more surrounding objects. The method includes providing training data amounts for a plurality of configurations of ultrasonic sensor systems. The training data amounts each include one or more training data sets for a corresponding measurement situation. The method also includes selecting configurations of ultrasonic sensor systems that are closest to the configuration of the new ultrasonic sensor system, at least with respect to configuration features.

### TECHNICAL FIELD

The invention relates to ultrasonic sensor systems for mobile devices, such as motor vehicles, and in particular methods for providing training data sets for training a classification model for the object classification on the basis of input data sets corresponding to and/or derived from ultrasonic sensor data.

### TECHNICAL BACKGROUND

Vehicles are typically equipped with ultrasonic sensor systems for object detection. These often have multiple ultrasonic transducers for different detection ranges in which surrounding objects are to be detected. Such an ultrasonic sensor system is often arranged on the front and/or rear bumper of a vehicle.

In addition to locating surrounding objects by evaluating the sensor data from the ultrasonic transducers, the sensor data may also be used to classify the surrounding objects. In particular, a classification should make it possible to differentiate between the height of surrounding objects, in particular with respect to whether the surrounding objects are traversable or non-traversable by the mobile device, i.e., whether they are conflict-relevant.

The classification of surrounding objects is typically done using classification models. These may be data-based, i.e., the classification model may be trained using a machine learning method using training data sets.

Ultrasonic sensor systems may differ between different types of vehicles in terms of configuration, i.e., in terms of the number, arrangement and types of ultrasonic transducers used, such that training data sets for the classification model of an ultrasonic sensor system may not readily be used for training a classification model in an ultrasonic sensor system having a different configuration. However, capturing training data sets for new configurations for ultrasonic sensor systems is complex and represents a significant amount of time prior to commissioning the ultrasonic sensor system.

### DISCLOSURE OF THE INVENTION

According to the present invention, there are provided a method for providing training data sets for training a classification model for a new configuration of an ultrasonic sensor system for a mobile device according to claim 1 as well as an apparatus and method of classification for object identification using an ultrasonic sensor system in a mobile device.

Further embodiments are specified in the dependent claims.

According to a first aspect, a method is provided, in particular computer-implemented method, for training a data-based classification model for a configuration of a new ultrasonic sensor system comprising a plurality of ultrasonic transducers using training data sets, wherein the classification model specifies, for one or more environmental objects, at least one class for an object property, wherein a training data set assigns an input data set from sensor data of the ultrasonic transducers and/or from sensor data features derived therefrom to a classification vector for one or more environmental objects, the method comprising the following steps:
providing training data amounts for a plurality of configurations of ultrasonic sensor systems, the training data amounts each comprising one or more training data sets for a corresponding measurement situation,
selecting configurations of ultrasonic sensor systems that are closest to the configuration of the new ultrasonic sensor system, at least with respect to configuration features,
selecting training data sets and validation data sets from the training data sets assigned to the selected configurations of ultrasonic sensor systems;
training the classification model for the configuration of the new ultrasonic sensor system on the basis of the selected training data sets and validation data sets.

In utilizing data-based classification models for object identification with ultrasonic sensor systems, one difficulty is to obtain sufficient training data sets. The training data sets are typically determined by recording sensor signals for different environmental situations. To do this, the environmental situations must be created and a measurement performed using the ultrasonic sensor system for which a classification model is to be created. The data-based classification model can comprise a neural network, a probabilistic regression model, a decision tree trained using a gradient boosting algorithm, or the like.

For example, each of the measurement situations provided for the creation of a training data set can be determined by one or more surrounding objects with the same or different object properties, such as heights, widths and the like, and with the same or different distances and/or orientations with respect to the ultrasonic sensor system.

The training data sets determined from different measurement situations each provide an input data set that comprises the sensor data and/or comprises features aggregated from the sensor data such as a maximum signal amplitude, a histogram of the number of multiple detections of the detected surrounding object, a proportion of point/line/single echo detections of the surrounding object, a proportion of detections with certain signal patterns, e.g. signal patterns that indicate pedestrians, in terms of amplitude, multiple reflections and the like, an average number of ultrasonic transducers that detect a certain surrounding object.

The surrounding object to be classified is classified accordingly, and a classification vector is provided as a label that each comprises a plurality of object classes for the one or more surrounding objects, each indicating the presence (or a model reliability of the presence) of a particular predefined object property. The classification vector forms the label for the corresponding training data set assigned to the measurement situation.

For a particular measurement situation, the input data sets of the training data sets will depend significantly on the configuration of the ultrasonic sensor system being considered. The configuration of the ultrasonic sensor system results from configuration features indicative of the number, arrangement, and types of ultrasonic transducers used, and the like. In particular, the arrangement may be determined by the features of the sensor installation height, the vertical installation angle of the ultrasonic transducers, the offset of the respective installation heights of the ultrasonic transducers and the horizontal installation angle of the ultrasonic transducers.

The above method now provides for the provision of training data sets for training the corresponding classification model for a new configuration of an ultrasonic sensor system by using training data sets already captured for other configurations of ultrasonic sensor systems, although these have been determined for a different configuration of ultrasonic sensor systems.

The method is based on training data amounts captured for multiple different configurations of ultrasonic sensor systems. Each training data amount is assigned to a configuration and comprises training data sets for different measurement situations with the particular configuration of the ultrasonic sensor system.

It may be provided that configuration features are determined by one or more arrangement features and one or more sensor type features, wherein the configurations of ultrasonic sensor systems are selected by selecting a number of nearest neighboring configuration feature points that span an area that includes a configuration feature point of the configuration of the new ultrasonic sensor system.

With regard to a new configuration of an ultrasonic sensor system, the nearest neighboring configurations of ultrasonic sensor systems already provided with training data amounts are selected first, i.e., the most similar configurations of the ultrasonic sensor systems are selected. The selection is made on the basis of the configuration features which may indicate the arrangement characterized by the arrangement features and the number of ultrasonic transducers in the ultrasonic sensor system in question, as well as the type of sensor determined by the sensor type features.

The arrangement features may comprise, for example, an installation height of the ultrasonic transducers above the subsurface, a vertical installation angle of the ultrasonic transducers, an offset of installation heights between the ultrasonic transducers and a horizontal installation angle of the ultrasonic transducers.

In particular, the configurations selected for ultrasonic sensor systems are those configurations of ultrasonic sensor systems that are the nearest neighboring configurations in terms of configuration features and that cover the smallest possible range in which the new configuration of the ultrasonic sensor system lies. In particular, the minimum number of selected nearest neighboring configurations for ultrasonic sensor systems is 1 more than the number of the configuration features under consideration.

With respect to the configuration features, the nearest neighboring configurations may be determined as the angular difference of the vectors determined by the configuration features in the feature space.

Alternatively, the nearest neighboring configurations may be determined as the Euclidean distance between the points in the feature space determined by the configuration features or as the Euclidean distance with respect to normalized configuration features. Furthermore, the configuration features may also be weighted to prioritize certain configuration features when determining the distance.

Training amounts of training data sets are available for each of the selected configurations, each comprising training data sets for different measurement situations.

Training data sets and validation data sets are selected from all of the training data amounts of the selected configurations for a given measurement situation or similar measurement situations. For example, similar measurement situations may be characterized on the basis of object features, such as the distance from the ultrasonic sensor device and the height of the surrounding object, wherein similarities between considered configurations can be described by falling below a predetermined maximum distance (Euclidean distance) with respect to the object features. This provides a series of training data sets and validation data sets for different measurement situations, which can each be used to train a new classification model for the new configuration of the ultrasonic sensor system.

Furthermore, the classification model may be re-trained with further training data sets for the configuration of the new ultrasonic sensor system.

It may be provided that a further training data set for a particular measuring situation is determined by a measurement when a model accuracy determined using the validation data sets assigned to the particular measuring situation or measuring situations similar to the particular measuring situation is below a predetermined threshold value.

If an evaluation with the validation data sets assigned to the corresponding measurement situation shows that the model accuracy for a measurement situation is too low, for example with a rate of correct classifications of less than a specified threshold percentage of e.g. 95%, it may be necessary to determine additional training data sets for the corresponding measurement situation for the new configuration of the ultrasonic sensor system in the conventional manner. However, since it is expected that the model accuracy is sufficient for at least a portion of the measurement situations, the determination of the training data for the measurement situation can be dispensed with and the overall effort required to determine training data sets can be considerably reduced.

In particular, the measurement situation may be determined by measurement features, wherein similar measurement situations are determined by the fact that measurement feature points, which are each determined by one or more measurement features of a measurement situation, are at a distance of no more than a predetermined maximum distance from the measurement feature point of the determined measurement situation, wherein in particular a measurement situation of a relative position and one or more object properties of the surrounding objects characterizing the measurement situation are determined.

According to one embodiment, the configurations of ultrasonic sensor systems may be selected for different measurement situations by selecting a number of nearest neighboring configuration feature points which, in addition to the one or more arrangement features and the one or more sensor type features, are also determined by one or more measurement features, in particular a relative position of one or more surrounding objects to the new ultrasonic sensor system, and/or an object property, in particular a height, such that they span an area that includes the configuration feature point of the configuration of the new ultrasonic sensor system including the one or more measurement features.

In this embodiment, an individual number of nearest neighboring configurations of ultrasonic sensor systems may be selected for each measurement situation, wherein a selection of the nearest neighboring configurations also considers at least one measurement feature, such as a height of the surrounding object and a distance to the ultrasonic sensor system, in addition to the configuration features. In this way, different nearest neighboring configurations of ultrasonic sensor systems may result for each measurement situation, from which the assigned training data sets and validation data sets for the relevant measurement situation are selected.

### BRIEF DESCRIPTION OF THE DRAWINGS

Preferred embodiments are described in more detail below with reference to the accompanying drawings. The figures show:

FIG. 1 a schematic illustration of a vehicle having an ultrasonic sensor system having a configuration of ultrasonic transducers;

FIG. 2 a flowchart illustrating a method for determining training data sets for training the classification model for object identification in the ultrasonic sensor system; and

FIG. 3 a diagram illustrating different designs of ultrasonic sensor systems with regard to two exemplary design features as a basis for selecting training data sets for a new design of an ultrasonic sensor system.

### DESCRIPTION OF EMBODIMENTS

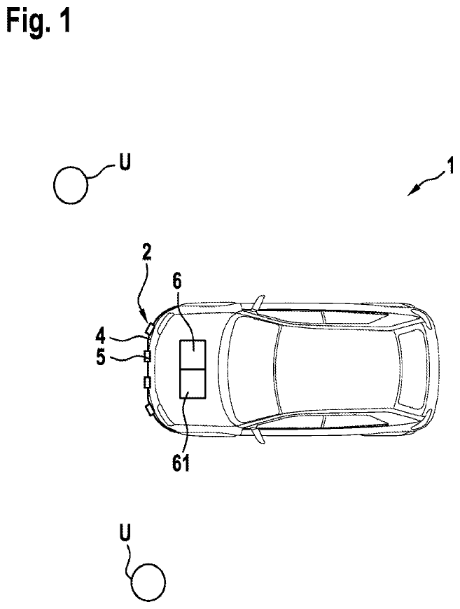

FIG. 1 shows a schematic representation of a vehicle 1 in the vehicle surroundings, in which one or multiple surrounding objects U can be located. The vehicle 1, by way of example a mobile apparatus, comprises an ultrasonic sensor system 2 arranged on a bumper 4. The ultrasonic sensor system 2 comprises multiple ultrasonic transducers 5 for emitting an ultrasonic signal with signal pulses and for receiving ultrasonic signals reflected from the surrounding objects U. The arrangement of the ultrasonic transducers 5 and the type of ultrasonic transducers 5 determine a configuration of the ultrasonic sensor system 2. Different types of vehicles 1 comprise different ultrasonic sensor systems 2 having different configurations.

A control unit 6 is provided, which is used to evaluate the sensor signals from the ultrasonic transducers 5 of the ultrasonic sensor system 2. In the control unit 6, a data-based classification model 61 is implemented in addition to a localization model for localizing the surrounding objects relative to the vehicle 1. The data-based classification model can comprise a neural network, a probabilistic regression model, a data-based decision tree trained using a gradient boosting algorithm, or the like. The sensor signals of the ultrasonic transducers 5 are evaluated in a known manner using ultrasound-based localization methods to create a virtual map of the surroundings in the control unit 6 and to enter the positions of detected surrounding objects U there.

The classification model 61 is trained on the configuration of the ultrasonic sensor system 2. Said model has or will be trained to perform a classification of surrounding objects U with respect to an object property, in particular their height, primarily in order to distinguish whether the surrounding object in question can or cannot be driven over by the vehicle 1, i.e. is collision-relevant. The classification model 61 is for this purpose trained to determine a classification result for each surrounding object U, which assigns an object property to each surrounding object U identified in the surroundings.

The detected surrounding objects are assigned to classification results using the classification model 61. The classification results classify the surrounding objects U according to the corresponding relevant object properties, in particular according to height classes.

The data-based classification model 61 assigns a classification vector to an input data set, which can comprise a signal time series of the sensor signals from the ultrasound transducers and/or signal features derived or aggregated therefrom. The classification vector comprises elements that quantify a possible class of the classification result for each identified surrounding object. The value of the element indicates the probability that object property assigned to the class is realized by the surrounding object U relating to the class. An argmax function of the elements of the classification vector assigned to a surrounding object can be used to output the specific class as a classification result for the model evaluation. The value of the element determined by argmax corresponds to the classification confidence.

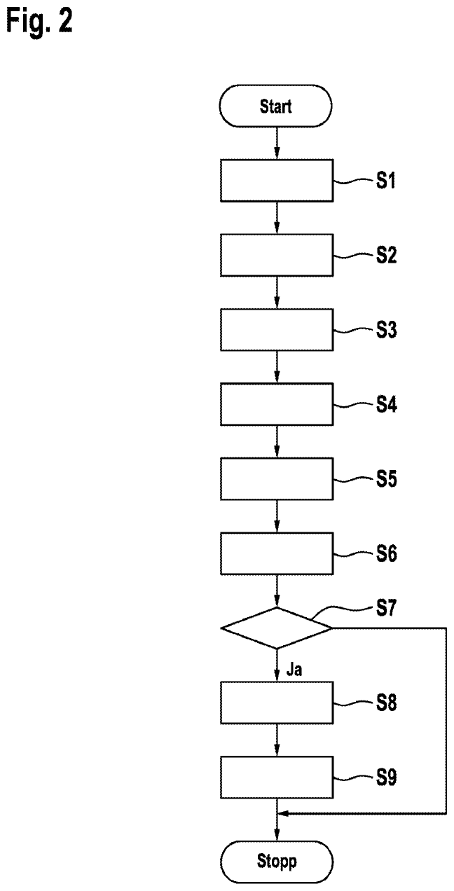

Up to now, when creating a data-based classification model 61 for a new configuration of an ultrasonic sensor system, training data sets have generally had to be identified in a time-consuming manner by measuring the measurement situations. For this purpose, measurement situations are simulated and corresponding signal time series of the sensor signals are recorded, input data sets are generated therefrom and these are assigned to a classification vector, which indicates the relevant object property of the surrounding object, usually in the form of a one-hot-coded vector, for each of the surrounding objects provided in the measurement situation. In order to reduce the measurement effort, a method is described below in conjunction with the flowchart of FIG. 2 that allows training data sets to be derived from other configurations of pre-measured ultrasonic sensor systems and used for training the classification model for the new configuration of the ultrasonic sensor system.

The method in FIG. 2 can be implemented as software or hardware in a conventional data processing apparatus and can in particular be performed offline, i.e., outside the vehicle in which the classification model 61 is intended to be used.

In step S1, a database is first provided in which training data amounts with training data sets for different measurement situations are available for several configurations of ultrasonic sensor systems 2. A measurement situation is generally determined by measurement features that indicate a relative position of one or more surrounding objects to the ultrasonic sensor system 2, or the distance from the ultrasonic sensor system and the orientation thereof, as well as a property of the surrounding object U, such as, for example, a height of the one or more surrounding objects U.

The different configurations of the ultrasonic sensor systems 2 are determined by characterizing configuration features, which may include, for example, arrangement features and sensor-type features. The arrangement features may comprise, for example, an installation height of the ultrasonic transducers, a vertical installation angle of the ultrasonic transducers, an offset of installation heights between the ultrasonic transducers and a horizontal installation angle of the ultrasonic transducers. Considering the sensor type in the sensor type feature may be particularly important, as ultrasonic transducer 5 may have different sensitivities and reception characteristics.

In step S2, the corresponding configuration features for the new configuration of the ultrasonic sensor system 2 are determined.

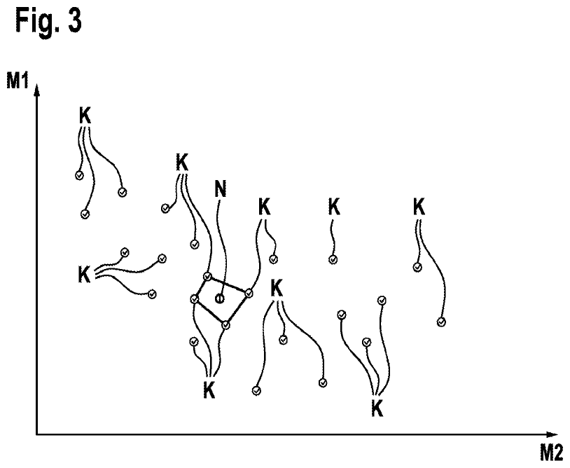

In step S3, a number of nearest neighboring configurations of ultrasonic sensor systems 2 is determined, wherein the number corresponds to at least a number of dimensions of the configuration feature space increased by 1. For example, as shown schematically in FIG. 3, for two design features M1, M2, such as the installation height and vertical installation angle as design features, there are multiple configuration feature points K of already measured ultrasonic sensor systems 2 in the database and a new configuration feature point N for configuring the ultrasonic sensor system 2 for which training data sets are to be provided. The nearest neighboring configuration feature points K of already measured ultrasonic sensor systems 2 are determined to define an area in the configuration feature space within which the new configuration feature point N lies.

In step S4, training data sets for a particular measurement situation or similar measurement situations assigned to the selected configurations of ultrasonic sensor systems 2 are now selected to select training data sets and validation data sets (for example, 80% training data sets and 20% validation data sets) therefrom for a subsequent model training of the classification model, in particular by random selection. This is done for different measurement situations, in particular for all available measurement situations. Measurement situations similar to the particular measurement situation may be determined on the basis of an angular distance of a feature vector determined by the measurement feature points in question or the Euclidean distance of the respective measurement feature points, which are each determined by one or more measurement features, for example all measurement feature points that are no more than a predetermined maximum angle or maximum distance away from the measurement feature point of the specific measurement situation.

Then, in step S5, model training is carried out with the training data records determined in this way.

In step S6, the validation data sets can now be used to determine separately for each measurement situation whether the trained classification model is sufficiently accurate. The accuracy may in particular be determined by the ratio of the correct/true classifications of the respective surrounding objects in relation to the total number of checks (number of validation data sets considered for this measurement situation).

If it is determined in step S7 that the proportion of the correct classifications is below a predetermined accuracy threshold (alternative: Yes), the trained classification model is not reliable for the specific measurement situation, and further training data sets must be determined in step S8 using conventional methods, in particular by measuring on the real system, for this or a similar measurement situation. With these, the classification model can then be re-trained in step S9. If it is determined in step S7 that the proportion of the correct classifications is above the predetermined accuracy threshold (alternative: no), the trained classification model is reliable for the specific measurement situation and steps S8 and S9 are not performed. Steps S7 to S9 are performed for each measurement situation.

The dependency on the configuration features is not equally pronounced for all surrounding objects, so that in some measurement situations varying configuration features do not have a major influence on the classification result, whereas in other measurement situations significant misclassifications can occur even with minor changes in the position of the surrounding objects. This means that the selection of the nearest neighboring configurations of ultrasonic sensor systems can take into account not only the design features but also one or more object properties of the surrounding object for each individual measurement situation and can be carried out separately for each measurement situation under consideration.

The number of selected nearest neighboring configurations of ultrasonic sensor systems may also be determined depending on the sensitivity of the classification result of the measurement situation.

Furthermore, the configuration features may also take into account the loading state of the vehicle, wherein two or more loading states can be taken into account accordingly. The loading state affects the effective installation height and the effective vertical installation angle of the ultrasonic transducers, such that the loading state can be considered when selecting the corresponding nearest neighboring configurations of ultrasonic sensor systems.

1. A computer-implemented method for training a data-based classification model for a configuration of a new ultrasonic sensor system comprising a plurality of ultrasonic transducers using training data sets, the classification model specifies, for one or more surrounding objects, at least one class for an object property, a training data set assigns an input data set from sensor data of the plurality of ultrasonic transducers and/or from sensor data features derived therefrom to a classification vector for the one or more surrounding objects, the method comprising:
providing training data amounts for a plurality of configurations of ultrasonic sensor systems, the training data amounts each comprising one or more training data sets for a corresponding measurement situation;
selecting configurations of ultrasonic sensor systems that are closest to the configuration of the new ultrasonic sensor system, at least with respect to configuration features;
selecting the training data sets and validation data sets from the training data sets assigned to the selected configurations of ultrasonic sensor systems; and
training the classification model for the configuration of the new ultrasonic sensor system based on the selected training data sets and the validation data sets.

2. The method of claim 1, wherein the classification model is retrained with further training data sets for the configuration of the new ultrasonic sensor system.

3. The method of claim 2, further comprising:
determining a further training data set for a particular measurement situation by a measurement when a model accuracy determined using the validation data sets assigned to the particular measurement situation or measurement situations similar to the particular measurement situation is below a predetermined threshold value.

4. The method of claim 3, wherein:
measurement situations are determined by measurement features,
similar measurement situations are determined by a fact that measurement feature points, which are each determined by one or more measurement features of a measurement situation, are at a distance of no more than a predetermined maximum distance from the measurement feature point of the determined measurement situation, and
a measurement situation of a relative position and one or more object properties of the surrounding objects characterizing the measurement situation are determined.

5. The method of claim 1, wherein:
the configuration features are determined by one or more arrangement features and one or more sensor type features, and
the configurations of ultrasonic sensor systems are selected by selecting a number of nearest neighboring configuration feature points that span an area that includes a configuration feature point of the configuration of the new ultrasonic sensor system.

6. The method of claim 5, wherein:
the configurations of ultrasonic sensor systems are selected for different measurement situations by selecting a number of nearest neighboring configuration feature points which, in addition to the one or more arrangement features and the one or more sensor type features, are also determined by one or more measurement features, including a relative position of one or more surrounding objects to the new ultrasonic sensor system, and/or an object property, including a height, such that they span an area that includes the configuration feature point of the configuration of the new ultrasonic sensor system including the one or more measurement features.

7. The method of claim 1, wherein the classification model is configured as a data-based decision tree.

8. A device for performing the method according to claim 1.

9. The method of claim 1, wherein a computer program product comprises instructions which, when executed by at least one data processing device, cause the data processing device to perform the method.

10. A non-transitory machine-readable storage medium comprising instructions which, when executed by at least one data processing device, cause the data processing device to perform the method according to claim 1.
